(19) United States
(12) Patent Application Publication
(10) Pub. No.: US 2024/0027618 A1
(43) Pub. Date: Jan. 25, 2024

(54) RANGING DEVICE

(71) Applicant: CANON KABUSHIKI KAISHA, Tokyo (JP)

(72) Inventor: DAISUKE KUROKI, Kanagawa (JP)

(21) Appl. No.: 18/351,753

(22) Filed: Jul. 13, 2023

(30) Foreign Application Priority Data
Jul. 25, 2022 (JP) 2022-117782

(51) Int. Cl. G01S 17/26; G01S 17/14; G01S 17/931; G01S 7/481

(52) U.S. Cl. CPC G01S 17/26; G01S 17/14; G01S 17/931; G01S 7/4816

(57) ABSTRACT

A ranging device includes a light receiving unit, a frequency distribution generation unit that generates a frequency distribution based on a timing at which light irradiated to an object is detected, a control unit that controls a frame period for counting of distance data, and a distance measurement result calculation unit that calculates a distance measurement result based on the frequency distribution. The distance measurement result calculation unit periodically acquires the frequency distribution during a predetermined period set as a frame period. When the frequency of any of the classes in the acquired frequency distribution exceeds a threshold value, the distance measurement result calculation unit determines a distance range of the class in which the frequency exceeds the threshold value as a distance measurement result, and the control unit outputs the distance measurement result before the predetermined period of time to end the frame period.

### BACKGROUND OF THE INVENTION

### Field of the Invention

The present invention relates to a ranging device.

### Description of the Related Art

As one of distance measuring methods for measuring a distance to an object using light, a distance measuring method called a time of flight (ToF) method is known. The ToF method is a method of measuring a distance to an object based on a time period from emission of light toward the object to detection of light reflected by the object. Japanese Patent Application Laid-Open No. 2019-002890, Japanese Patent Application Laid-Open No. 2021-067534, and Japanese Patent Application Laid-Open No. 2016-095234 disclose a ranging device that measures a distance to an object by a ToF method.

The ranging device is required to have various characteristics depending on the application, and one of them is high responsiveness. For example, in a ranging device mounted on a vehicle, in order to take measures such as collision avoidance at appropriate timings for sudden obstacles or rapid changes in speed of an oncoming vehicle, it is required to acquire a distance measurement result quickly. However, the techniques described in Japanese Patent Application Laid-Open No. 2019-002890, Japanese Patent Application Laid-Open No. 2021-067534, and Japanese Patent Application Laid-Open No. 2016-095234 cannot always obtain sufficient responsiveness.

### SUMMARY OF THE INVENTION

An object of the present invention is to provide a high-response ranging device capable of quickly outputting a distance measurement result according to a state change of a measurement region.

According to an embodiment of the present disclosure, there is provided a ranging device including a light receiving unit including a light receiving element, a frequency distribution generation unit configured to generate a frequency distribution indicating a relationship between a distance and a frequency based on a timing at which light irradiated to an object is detected by the light receiving element, a control unit configured to control a frame period that is a period from a start to an end of counting of distance data in the frequency distribution generation unit, and a distance measurement result calculation unit configured to calculate a distance measurement result based on the frequency distribution, wherein the distance measurement result calculation unit periodically acquires the frequency distribution from the frequency distribution generation unit during a predetermined period set in advance as the frame period, wherein, when the frequency of any of the classes in the acquired frequency distribution exceeds a predetermined threshold value, the distance measurement result calculation unit determines a distance range of a class in which the frequency exceeds the threshold value as a distance measurement result, and the control unit outputs the distance measurement result from the distance measurement result calculation unit before the predetermined period to elapse, and ends the frame period.

According to another embodiment of the present disclosure, there is provided an information processing device that processes distance data indicating a distance to an object including a frequency distribution generation unit configured to generate a frequency distribution by counting of distance data for each class defined by distances, a control unit configured to control a frame period that is a period from a start to an end of counting of the distance data in the frequency distribution generation unit, and a distance measurement result calculation unit configured to calculate a distance measurement result based on the frequency distribution, wherein the distance measurement result calculation unit periodically acquires the frequency distribution from the frequency distribution generation unit during a predetermined period set in advance as the frame period, wherein, when the frequency of any of the classes in the acquired frequency distribution exceeds a predetermined threshold value, the distance measurement result calculation unit determines a distance range of a class in which the frequency exceeds the threshold value as a distance measurement result, and the control unit outputs the distance measurement result from the distance measurement result calculation unit before the predetermined period to elapse, and ends the frame period.

According to still another embodiment of the present specification, there is provided a method of measuring a distance by generating a frequency distribution indicating a relationship between a distance and a frequency based on a timing at which light irradiated to an object is detected by a light receiving element, and calculating a distance measurement result based on the frequency distribution, the method including periodically acquiring the frequency distribution during a predetermined period set in advance as a frame period that is a period from a start to an end of the counting of the distance data, determining whether or not the frequency of any of the classes in the acquired frequency distribution exceeds a predetermined threshold value, and when the frequency exceeds the threshold value, determining a distance range of a class in which the frequency exceeds the threshold value as a distance measurement result, and ending the frame period before the predetermined period to elapse.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a ranging device according to a first embodiment of the present invention.

FIG. 2 is a diagram illustrating an example of histogram information generated in the ranging device according to the first embodiment of the present invention.

FIG. 3 is a timing chart illustrating an example of an external output timing of a distance measurement result in the ranging device according to the first embodiment of the present invention.

FIG. 4 is a flowchart illustrating an operation of a frame control unit in the ranging device according to the first embodiment of the present invention.

FIG. 5 is a diagram illustrating an example of threshold value information generated in the ranging device according to the first embodiment of the present invention.

FIG. 6A, FIG. 6B, FIG. 6C, and FIG. 6D are diagrams illustrating an example of generating a determination threshold value in the ranging device according to the first embodiment of the present invention.

FIG. 7 is a block diagram illustrating a schematic configuration of a ranging device according to a second embodiment of the present invention.

FIG. 8A, FIG. 8B, FIG. 8C, and FIG. 8D are diagrams illustrating an example of generating a determination threshold value in the ranging device according to the second embodiment of the present invention.

FIG. 9A and FIG. 9B are diagrams illustrating a configuration example of a movable object according to a third embodiment of the present invention.

### DESCRIPTION OF THE EMBODIMENTS

As described above, as one of the characteristics required for the ranging device, there is a high responsiveness capable of quickly outputting the distance measurement result. In a general ranging device, the interval at which the distance measurement result is output is constant, and the response can be improved by shortening the output interval. However, if the output period is uniformly shortened in order to improve the responsiveness, the number of times of the optical cycle processing in the measurement period decreases. Since reducing the number of times of the optical cycle processing and increasing the distance measurement accuracy are in a trade-off relationship, by reducing the number of times of the optical cycle processing, the number of times of receiving the reflected light from the object is reduced, and therefore, there is a possibility that an accurate distance measurement result cannot be obtained.

For example, in Japanese Patent Application Laid-Open No. 2019-002890, for the purpose of reducing power consumption, the number of times of optical cycle processing and the measurement period for obtaining the next distance measurement result are changed from the previous distance measurement result. By extending the interval of the optical cycle processing and the measurement period, the amount of processing per unit time can be reduced and power consumption can be reduced. However, in Japanese Patent Application Laid-Open No. 2019-002890, since the next measurement period is changed from the previous measurement result, there is a time lag in the change of the measurement period, and the measurement result cannot be immediately obtained when a sudden event occurs.

Further, in Japanese Patent Application Laid-Open No. 2021-067534, for the purpose of reducing the output data amount of the distance measurement result, after the distance measurement result is acquired, the frequency of output of the data having the object in a short distance and the data having the object in a long distance is changed. However, in Japanese Patent Application Laid-Open No. 2021-067534, the measurement period until the distance measurement result is obtained is not shortened only by changing the output frequency of the distance measurement result between the long distance and the short distance. Therefore, when a sudden event occurs, a distance measurement result cannot be obtained immediately.

Further, in Japanese Patent Application Laid-Open No. 2016-095234, a measurement period is divided into a plurality of sub-measurement periods, and a short-time exposure result is output in the sub-period and a long-time exposure result is output in the measurement period, thereby shortening a measurement period for a short-distance object. With this configuration, the presence or absence of a short-distance object can be obtained without waiting for the end of the measurement period. However, in Japanese Patent Application Laid-Open No. 2016-095234, a result of short-time exposure and a result of long-time exposure are output a plurality of times within a measurement period, so that the amount of data transferred increases. Further, since the final distance measurement result cannot be determined until the result of the long-time exposure after the measurement period is obtained, processing overhead occurs outside.

Preferred embodiments of the present invention will now be described in detail in accordance with the accompanying drawings.

### First Embodiment

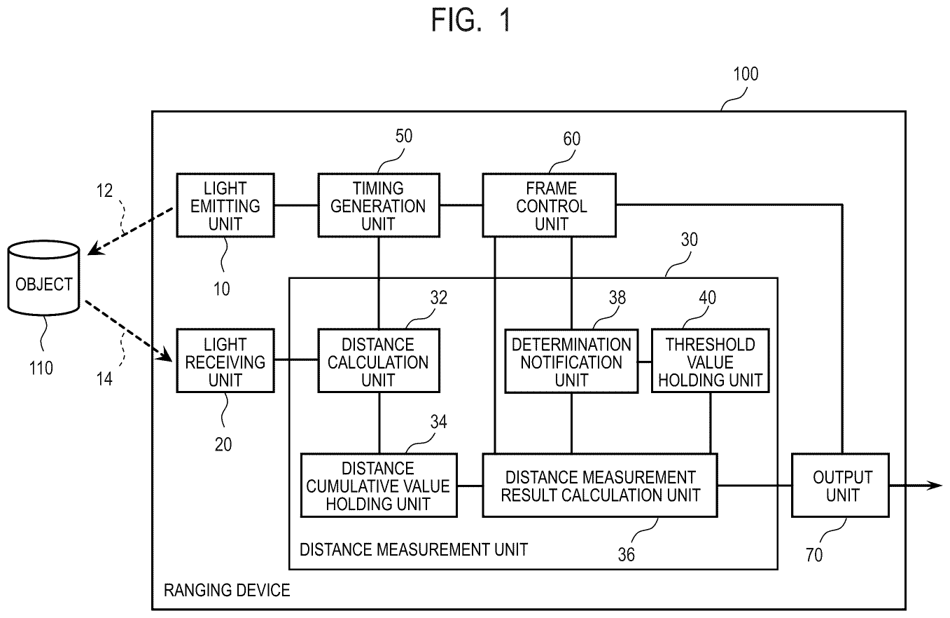

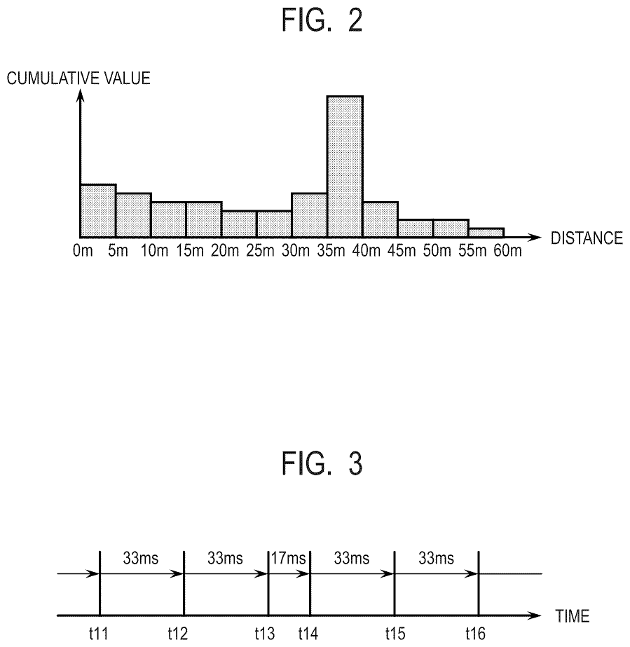

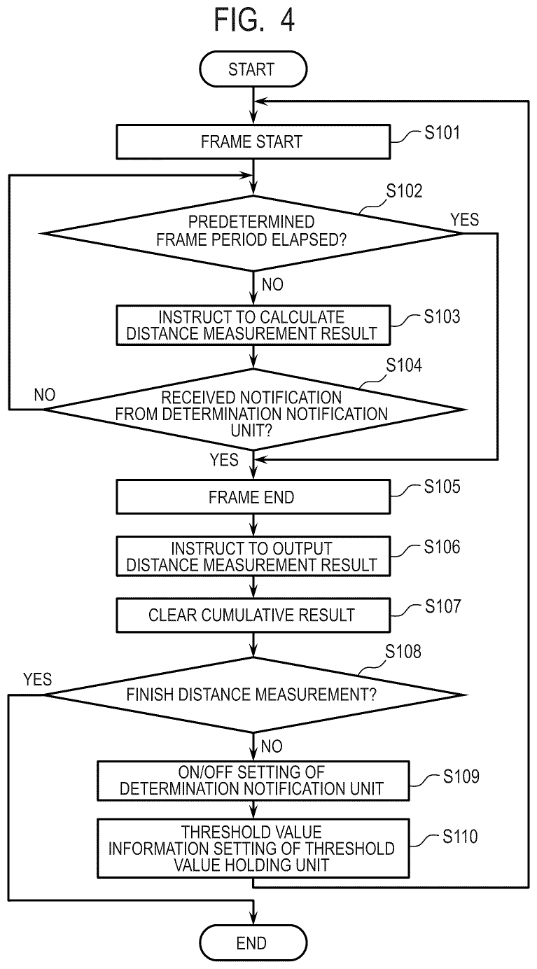

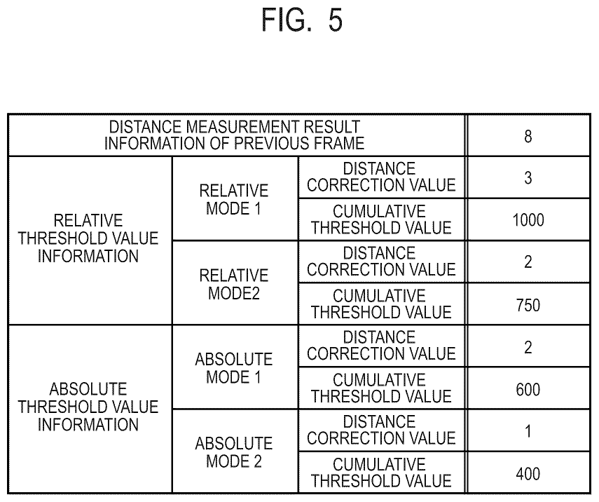

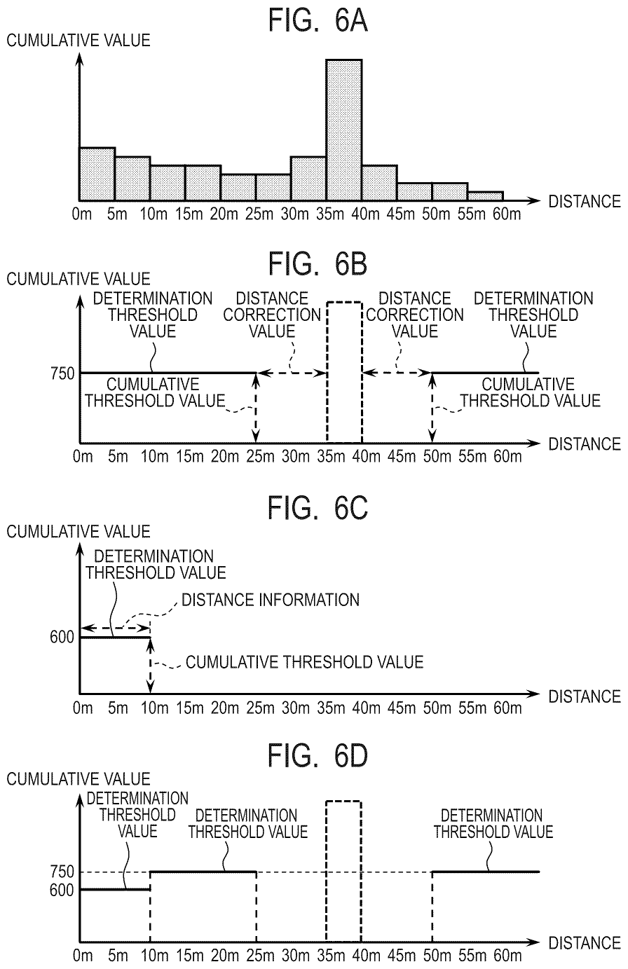

A ranging device and a method of measuring a distance according to a first embodiment of the present invention will be described with reference to FIG. 1 to FIG. 6D. FIG. 1 is a block diagram illustrating a schematic configuration of a ranging device according to the present embodiment. FIG. 2 is a diagram illustrating an example of histogram information generated in the ranging device according to the present embodiment. FIG. 3 is a timing chart illustrating an example of an external output timing of a distance measurement result in the ranging device according to the present embodiment. FIG. 4 is a flowchart illustrating an operation of a frame control unit in the ranging device according to the present embodiment. FIG. 5 is a diagram illustrating an example of threshold value information generated in the ranging device according to the present embodiment. FIG. 6A to FIG. 6D are diagrams illustrating an example of generating a determination threshold value in the ranging device according to the present embodiment.

First, a schematic configuration of a ranging device according to the present embodiment will be described with reference to FIG. 1. The ranging device 100 according to the present embodiment includes a light emitting unit 10, a light receiving unit 20, a distance measurement unit 30, a timing control unit 50, a frame control unit 60, and an output unit 70. The distance measurement unit 30 includes a distance calculation unit 32, a distance cumulative value holding unit 34, a distance measurement result calculation unit 36, a determination notification unit 38, and a threshold value holding unit 40.

The timing control unit 50 is connected to the light emitting unit 10, the distance calculation unit 32, and the frame control unit 60. The light receiving unit 20 is connected to the distance calculation unit 32. The distance calculation unit 32 is connected to the distance cumulative value holding unit 34. The distance cumulative value holding unit 34 is connected to the distance measurement result calculation unit 36. The distance measurement result calculation unit 36 is connected to the determination notification unit 38, the threshold value holding unit 40, and the output unit 70. The threshold value holding unit 40 is connected to the determination notification unit 38. The determination notification unit 38 is connected to the frame control unit 60. The frame control unit 60 is connected to the distance measurement result calculation unit 36 and the output unit 70.

The light emitting unit 10 includes a light emitting element (not illustrated), and has a role of emitting pulsed light (irradiation light 12) such as laser light emitted from the light emitting element to a measurement target region. As the light emitting element constituting the light emitting unit 10, for example, an element capable of high-speed modulation such as an LED (Light Emitting Diode) or an LD (Laser Diode) may be applied. The light emitting element may be VCSEL (Vertical Cavity Surface Emitting Laser) or a surface light emitting element in which the light emitting elements are arranged in an array. The light emitting unit 10 is desirably configured to emit light of a uniform amount of light to the measurement target region, and may further include an optical element for optically converting light emitted from the light emitting element to emit light to the measurement target region, for example, a lens.

The light receiving unit 20 includes a light receiving element (not illustrated) and has a role of detecting light incident from the measurement target region. For example, a CMOS (Complementary Metal-Oxide-Semiconductor) sensor, a SPAD (Single Photon Avalanche Diode) sensor, or the like may be applied as the light receiving element constituting the light receiving unit 20. The light incident on the light receiving unit 20 includes light (reflected light 14) reflected by the object 110 in the measurement target area among the irradiation light 12. The light receiving unit 20 converts the optical signal detected by the light receiving element into an electrical signal and outputs the electrical signal to the distance calculation unit 32. A pulse signal corresponding to the pulsed light of the irradiation light 12 is superimposed on the electric signal output to the distance calculation unit 32. The light receiving unit 20 may further include an optical element, for example, a lens, for efficiently guiding the reflected light 14 to the light receiving element.

The timing control unit 50 has a function of controlling the overall operation of the ranging device 100. For example, the timing control unit 50 generates a control signal for controlling the emission timing of the pulsed light, and transmits the generated control signal to the light emitting unit 10. Further, the timing control unit 50 measures an elapsed time from the emission timing of the pulsed light in the light emitting unit 10, and transmits time information indicating the elapsed time to the distance calculation unit 32. The timing control unit 50 controls the operation of the frame control unit 60.

The distance measurement unit 30 has a role of acquiring distance information of the object 110 based on a signal from the timing control unit 50 and the light receiving unit 20, and transmitting a distance measurement result to the output unit 70 based on a signal from the frame control unit 60. The distance information of the object 110 is generated by the distance calculation unit 32 and the distance cumulative value holding unit 34. The calculation and output of the distance measurement result are performed by the distance measurement result calculation unit 36, the determination notification unit 38, and the threshold value holding unit 40 based on the signal from the frame control unit 60.

The distance calculation unit 32 calculates a distance to the object 110 based on the signal received from the light receiving unit 20 and the time information received from the timing control unit 50, and transmits the calculated distance to the distance cumulative value holding unit 34.

The distance cumulative value holding unit 34 has a role of generating a frequency distribution (hereinafter referred to as histogram information) indicating a relationship between classes of distance (hereinafter referred to as bins) and the frequencies of the bins based on information acquired from the distance calculation unit 32, and holding the generated histogram information. The distance cumulative value holding unit 34 is a frequency distribution generation unit that generates a frequency distribution indicating a relationship between a distance and a frequency based on a timing at which the light irradiated to the object 110 is detected by the light receiving element. The histogram information will be described later.

The frame control unit 60 serves as a control unit for controlling a frame period, which is a period from the start to the end of the counting of the distance data in the distance cumulative value holding unit 34. The frame control unit 60 transmits a distance measurement result output instruction and a distance measurement result calculation instruction to the distance measurement result calculation unit 36. The distance measurement result output instruction is a signal transmitted from the frame control unit 60 to the distance measurement result calculation unit 36 every time a predetermined frame period elapses or in response to a frame end notification from the determination notification unit 38. The distance measurement result calculation instruction is a signal periodically transmitted from the frame control unit 60 to the distance measurement result calculation unit 36 during one frame period. Note that the frame period may be defined as a period from a timing at which the distance measurement is newly started in a state in which the histogram information of the distance cumulative value holding unit 34 is empty to a timing at which the distance measurement result is output to the outside and the histogram information is deleted.

The distance measurement result calculation unit 36 has a role of calculating a distance measurement result based on the histogram information held by the distance cumulative value holding unit 34. The distance measurement result calculation unit 36 receives the histogram information from the distance cumulative value holding unit 34 in response to the distance measurement result output instruction or the distance measurement result calculation instruction received from the frame control unit 60. Further, the distance measurement result calculation unit 36 acquires information on a bin corresponding to the distance to the object 110 and its frequency (integral value) from the received histogram information, and outputs the acquired information to the determination notification unit 38, the threshold value holding unit 40, and the output unit 70.

The determination notification unit 38 determines whether or not the cumulative value acquired from the distance measurement result calculation unit 36 exceeds a threshold value held by the threshold value holding unit 40, and notifies the frame control unit 60 of the determination result. It may also be said that the determination notification unit 38 is a part of the control unit for controlling the frame period. The threshold value held by the threshold value holding unit 40 will be described later.

The output unit 70 outputs the distance measurement information received from the distance measurement unit 30 to the outside based on the signal from the frame control unit 60.

The distance measurement unit 30, the timing control unit 50, and the frame control unit 60 may be configured to operate in accordance with a program incorporated in advance, or may be configured by a circuit (for example, ASIC (Application Specific Integrated circuit)) that realizes one or more functions.

Next, a specific operation of the ranging device according to the present embodiment will be described with reference to FIG. 1 to FIG. 6D.

The light emitting unit 10 emits pulsed light (irradiation light 12) such as laser light to the measurement target region in accordance with an instruction of a light emission timing from the timing control unit 50. The light receiving unit 20 detects light incident from the measurement target region. The light incident on the light receiving unit 20 includes light (reflected light 14) reflected by the object 110 in the measurement target area among the irradiation light 12. The light receiving unit 20 converts the optical signal detected by the light receiving element into an electrical signal and outputs the electrical signal to the distance calculation unit 32. A pulse signal corresponding to the irradiation light 12 is superimposed on the electric signal output to the distance calculation unit 32.

The timing control unit 50 measures an elapsed time from the instruction of the light emission timing to the light emitting unit 10, and transmits time information indicating the elapsed time to the distance calculation unit 32. The distance calculation unit 32 calculates a distance to the object 110 based on the signal received from the light receiving unit 20 and the time information received from the timing control unit 50, and transmits distance information indicating the calculated distance to the distance cumulative value holding unit 34. The distance D [m] to the object 110 is calculated by the following equation (1). Here, t is the time information (unit: second) received from the timing control unit 50 at the timing when the pulse signal is received from the light receiving unit 20, and c is the speed of light (2.998×10⁸ [m/second]).

D=c×t/2 [m] (1)

The distance cumulative value holding unit 34 has a role of generating the histogram information indicating a relationship between the classes of distance (bins) and the frequency of each bin based on the distance information acquired from the distance calculation unit 32, and holding the generated histogram information. FIG. 2 illustrates an example of the histogram information generated in the distance cumulative value holding unit 34. In the histogram information of FIG. 2, the horizontal axis represents the bins each indicating the class of the distance, and the vertical axis represents the frequency of each bin. In the example of FIG. 2, one bin is provided every 5 meters in a range from a distance of 0 meter to a distance of 60 meters. The number of times the distance information is received from the distance calculation unit 32 (cumulative value) is defined as the frequency of each bin. The width of each bin and the range in which the bin is set may be arbitrarily selected depending on the application.

Upon receiving the distance information from the distance calculation unit 32, the distance cumulative value holding unit 34 increases the value of the corresponding bin by 1, and holds the result. For example, when a value of 38 meters is received as the distance information from the distance calculation unit 32, the value of the bin corresponding to the range of 35 meters to 40 meters is increased by 1. The histogram information illustrated in FIG. 2 can be generated by repeating the period from the irradiation of the pulsed light to the acquisition of the distance information as one period (hereinafter referred to as “optical cycle processing”) during a predetermined measurement period.

The light detected by the light receiving unit 20 includes a disturbance light in addition to the reflected light 14 from the object 110. The disturbance light is randomly incident light and becomes noise with respect to the reflected light 14. On the other hand, since the reflected light 14 is light detected at a timing corresponding to the distance to the object 110, it can be determined that a bin corresponding to the peak frequency in the histogram information corresponds to the distance to the object 110. By using the histogram information obtained as a result of the optical cycle processing, influence of random noise such as disturbance light may be reduced, and an appropriate distance measurement result may be acquired.

However, the amount of noise caused by the disturbance light or the like may vary depending on the difference in the measurement environment, for example, in a bright place such as a daytime or a freight street, and in a dark place such as a nighttime or a mountain. The frequency of acquisition of the reflected light 14 from the object 110 varies depending on the reflectance of the object 110 and the distance to the object 110. Therefore, in order to obtain an appropriate distance measurement result, it is necessary to obtain the histogram information by performing a sufficient number of optical cycle processing.

The distance measurement result calculation unit 36 operates in response to the distance measurement result calculation instruction or the distance measurement result output instruction from the frame control unit 60. When the distance measurement result calculation unit 36 receives the distance measurement result calculation instruction or the distance measurement result output instruction from the frame control unit 60, the distance measurement result calculation unit 36 first acquires the histogram information from the distance cumulative value holding unit 34, determines the distance to the object 110 from the acquired histogram information, and acquires the distance measurement result. For example, when the histogram information of FIG. 2 is received from the distance cumulative value holding unit 34, it is determined that the object 110 exists in a bin with the largest frequency, i.e., in a range of 35 meters to 40 meters, and this is determined as a distance measurement result.

The frame control unit 60 transmits the distance measurement result output instruction to the distance measurement result calculation unit 36 each time a predetermined frame period elapses under the control of the timing control unit 50. When receiving the distance measurement result output instruction from the frame control unit 60, the distance measurement result calculation unit 36 acquires the distance measurement result, then outputs the distance measurement result to the outside via the output unit 70, and transmits the distance measurement result to the threshold value holding unit 40. When the distance measurement result calculation unit 36 outputs the distance measurement result, the frame period ends.

Further, under the control of the timing control unit 50, the frame control unit 60 periodically transmits the distance measurement result calculation instruction to the distance measurement result calculation unit 36 during the frame period separately from the distance measurement result output instruction. Upon receiving the distance measurement result calculation instruction, the distance measurement result calculation unit 36 acquires the distance measurement result, and then transmits the distance information as the distance measurement result and the cumulative value of the corresponding distance to the determination notification unit 38.

Upon receiving the distance information and the cumulative value from the distance measurement result calculation unit 36, the determination notification unit 38 acquires a threshold value information held by the threshold value holding unit 40, and determines whether or not the cumulative value received from the distance measurement result calculation unit 36 exceeds a threshold value acquired from the threshold value holding unit 40. As a result of the determination, when the cumulative value exceeds the threshold value, the determination notification unit 38 transmits a frame end notification to the frame control unit 60 in order to immediately end the frame. When the frame control unit 60 receives the frame end notification from the determination notification unit 38, the frame control unit 60 transmits the distance measurement result output instruction to the distance measurement result calculation unit 36, instructs the distance cumulative value holding unit 34 to erase the histogram information, and ends the frame. After the end of the frame, a new frame is started. As a result of the determination, when the cumulative value does not exceed the threshold value, the frame control unit 60 is not notified, and the distance measurement processing is continued.

An example of an external output timing of the distance measurement result will be described with reference to FIG. 3. In FIG. 3, times t11, t12, t13, t14, t15, and t16 are timings at which the distance measurement result is output to the outside, i.e., end timings of a frame period. Each of the periods between the times t11, t12, t13, t14, t15, and t16 is one frame period. In FIG. 3, it is assumed that a predetermined length of one frame period is 33 ms (frame rate: 30 fps).

As illustrated in FIG. 3, the length of the frame period in the distance measurement method of the present embodiment varies according to the timing of the distance measurement result output instruction received by the distance measurement result calculation unit 36 from the frame control unit 60. That is, the frame periods ending at each of the times t12, t13, t15, and 16 are ended in response to the distance measurement result output instruction received from the frame control unit 60 at intervals of a predetermined frame period, and the length thereof is 33 ms. On the other hand, the frame period which ends at time t14 ends in response to the distance measurement result output instruction received from the frame control unit 60 in response to the frame end notification from the determination notification unit 38, and is 17 ms shorter than the predetermined frame period. In this way, normally, the distance measurement result is output to the outside at every predetermined frame period, but when the cumulative value of the distance measurement result exceeds a certain threshold value, the distance measurement result is output to the outside at that time point without waiting for the elapse of the predetermined period. The length of the frame period set in advance may be appropriately determined according to various factors including power consumption due to the output frequency and the number of times of optical cycle processing necessary to stably obtain an appropriate distance measurement result.

Next, the operation of the frame control unit 60 will be described in detail with reference to FIG. 4.

First, in step S101, a new frame is started under the control of the timing control unit 50. That is, in a state in which the histogram information in the distance cumulative value holding unit 34 is empty, the optical cycle processing is newly started. After the processing in step S101, the processing proceeds to step S102.

In step S102, the frame control unit 60 determines whether or not a time corresponding to the predetermined frame period has elapsed from the frame start time. As a result of the determination, when the time corresponding to the predetermined frame period has not elapsed (NO), the process proceeds to step S103. On the other hand, if the determination result indicates that the time corresponding to the predetermined frame period has elapsed (YES), the processing proceeds to step S105.

In step S103, the frame control unit 60 transmits the distance measurement result calculation instruction to the distance measurement result calculation unit 36. After the processing in step S103, the processing proceeds to step S104.

In step S104, the frame control unit 60 determines whether or not the frame end notification is received from the determination notification unit 38. As a result of the determination, when the frame end notification is not received from the determination notification unit 38 (NO), the processing returns to step S102. On the other hand, as a result of the determination, when the frame end notification is received from the determination notification unit 38 (YES), the processing proceeds to step S105.

In step S105, the frame control unit 60 proceeds to frame end processing. In the frame end processing, first, in step S106, the distance measurement result output instruction is transmitted to the distance measurement result calculation unit 36. Upon receiving the distance measurement result output instruction, the distance measurement result calculation unit 36 outputs the distance measurement result to the outside via the output unit 70 and transmits the distance measurement result to the threshold value holding unit 40. Next, in step S107, the histogram information held by the distance cumulative value holding unit 34, i.e., the cumulative value in each bin, is initialized to zero (the cumulative result is cleared). After the processing in step S107, the processing proceeds to step S108.

In step S108, the frame control unit 60 confirms whether or not to end the distance measurement by the ranging device 100. As a result of the confirmation, when the distance measurement is ended (YES), the series of processing is terminated. As a result of the confirmation, when the distance measurement is continued (NO), the processing proceeds to step S109.

In step S109, a setting of the determination notification unit 38 for processing in the next frame is performed as necessary. The setting of the determination notification unit 38 may include setting of ON/OFF of the determination notification from the determination notification unit 38. After the processing in step S109, the processing proceeds to step S110.

In step S110, a setting of the threshold value information for processing in the next frame is performed as necessary. After the processing in step S110, the processing returns to step S101 to start the process of the next frame.

Typically, the threshold value held by the threshold value holding unit 40 may be set to such a value that, if the cumulative value transmitted together with the distance measurement result from the distance measurement result calculation unit 36 exceeds this value, it can be determined that a sufficiently reliable distance measurement result has been obtained. The threshold value may be set for each of the plurality of bins constituting the histogram information. However, the threshold value information held in the threshold value holding unit 40 is not limited to this example, and may include other information.

Next, another example of the threshold value information included in the threshold value holding unit 40 will be described with reference to FIG. 5.

For example, as illustrated in FIG. 5, the threshold value information held in the threshold value holding unit 40 may be an information table including three pieces of information of “distance measurement result information of previous frame”, “relative threshold value information”, and “absolute threshold value information”. The “relative threshold value information” is threshold value information determined based on a relative relationship with a distance measurement result in a previous frame. The “absolute threshold value information” is threshold value information determined based on an absolute value of the distance. Each of the “relative threshold value information” and the “absolute threshold value information” may include a plurality of setting modes. Each of the setting modes of the “relative threshold value information” may include different distance correction values and different cumulative threshold values. Each of the setting modes of the “absolute threshold value information” may include different distance information and different cumulative threshold values.

In the example of FIG. 5, “the distance measurement result information of previous frame” is 8. The “relative threshold value information” includes two modes, a relative mode 1 and a relative mode 2, as setting modes. The distance correction value of the relative mode 1 is 3, and the cumulative threshold value of the relative mode 1 is 1000. The distance correction value of the relative mode 2 is 2, and the cumulative threshold value of the relative mode 2 is 750. The “absolute threshold value information” includes two modes, an absolute mode 1 and an absolute mode 2, as setting modes. The distance information of the absolute mode 1 is 2, and the cumulative threshold value of the absolute mode 1 is 600. The distance information of the absolute mode 2 is 1, and the cumulative threshold value of the absolute mode 2 is 400.

The “distance measurement result information of previous frame” may be, for example, the distance measurement result information in the immediately preceding frame period. A value 8 of the “distance measurement result information of previous frame” indicates an index of a bin in the histogram information. That is, the value of 8 indicates, for example, an eighth bin in the histogram information of FIG. 2 when the bins are labelled in order such that the bin of 0 m to 5 m is assigned as 1, the bin of 5 m to 10 m is assigned as 2, . . . , and corresponds to the bin of a distance of 35 m to 40 m indicating the peak frequency. The “distance measurement result information of previous frame” may be updated when the distance measurement result is transmitted from the distance measurement result calculation unit 36 in step S106 of FIG. 4.

The distance correction value in the “relative threshold value information” indicates the number of bins from the bin indicated in the “distance measurement result information of previous frame”. The distance information in the “absolute threshold value information” indicates the number of bins from the distance 0. The cumulative threshold values in the “relative threshold value information” and the “absolute threshold value information” indicate the cumulative values in the histogram information.

As the threshold value information used in the determination notification unit 38, which the relative mode 1 or the relative mode 2 is used and which the absolute mode 1 or the absolute mode 2 is used may be switched depending on the distance measurement environment or the like. Further, the setting value itself may be changed as necessary. The mode switching, the setting value change, and the like may be performed in step S110 of FIG. 4.

Next, an example of generating the determination threshold value used for the determination in the determination notification unit 38 will be described with reference to FIG. 6A to FIG. 6D. The determination threshold value used for the determination in the determination notification unit 38 is generated based on the information table held by the threshold value holding unit 40. Here, it is assumed that the threshold value holding unit 40 holds the information table illustrated in FIG. 5. Further, it is assumed that the distance correction value and the cumulative threshold value of the relative mode 2 and the distance information and the cumulative threshold value of the absolute mode 1 are used as the relative threshold value information and the absolute threshold value information in the generation of the determination threshold value.

FIG. 6A illustrates an example of the histogram information in a previous frame. The eighth bin corresponding to the distance of 35 m to 40 m indicating the peak frequency is stored as index 8 in the column of “distance measurement result information of previous frame” in the information table.

FIG. 6B is a diagram illustrating the determination threshold value generated using the “distance measurement result information of previous frame” in the information table of FIG. 5, the distance correction value and the cumulative threshold value of the relative mode 2. The determination threshold value based on the “distance measurement result information of previous frame” and the “relative threshold value information” is set to bins excluding a bin corresponding to the distance measurement result output in the previous frame and a predetermined number of bins adjacent thereto. For example, as indicated by solid lines in FIG. 6B, the determination threshold value is set to the bins spaced apart two or more bins, that is given as the “distance correction value”, from the bin indicated in the column of “distance measurement result information of previous frame” at a height position of the cumulative value 750 given as the cumulative threshold value.

The range defined by the distance correction value of the relative mode is set based on a distance range in which the distance measuring object can be moved by a normal state change from a position where the distance measuring object exists in the previous frame. In other words, if the position of the distance measuring object changes within the range defined by the distance correction value of the relative mode, the frame need not be ended within a predetermined frame period.

The cumulative threshold value of the relative mode is a value that can be determined to obtain a sufficiently reliable distance measurement result if the peak value exceeds this cumulative value. That is, when the determination threshold value in FIG. 6B is exceeded within the frame period, it is considered that a rapid state change such as rapid braking or rapid acceleration occurs in the distance measuring object in the previous frame. Accordingly, in such a case, even within a predetermined frame period, it is desirable that the frame period be ended and the distance measurement result be immediately output.

FIG. 6C is a diagram illustrating a determination threshold value generated using the distance information and the cumulative threshold value of the absolute mode 1. As indicated by a solid line in FIG. 6C, the determination threshold value is set to a height position of the cumulative value 600 given as the cumulative threshold value in a range of two bins given as a “distance correction value” from the distance 0 m.

The range defined by the distance information of the absolute mode is set based on a range in which an object is generated in a short distance by such as jumping out of the object and an emergency response such as braking or collision avoidance is required. The cumulative threshold value of the absolute mode is a height at which a reliable distance measurement result can be barely determined as long as the peak value exceeds the cumulative value. That is, when the determination threshold value in FIG. 6C is exceeded within the frame period, it is considered that an object is generated in a short distance, and emergency response such as braking or collision avoidance is necessary. Accordingly, in such a case, even within a predetermined frame period, it is desirable that the frame be terminated and the distance measurement result be immediately output. From the viewpoint of outputting the distance measurement result at an earlier timing when an object is generated at a shorter distance, it is desirable to reduce the threshold value set in the bins positioned at the shorter distance side.

FIG. 6D is a diagram illustrating the final determination threshold value generated from the determination threshold value based on the relative threshold value information and the determination threshold value based on the absolute threshold value information. Solid lines in FIG. 6D indicate the final determination threshold value. In the distance range where only one of the determination threshold value based on the relative threshold value information and the determination threshold value based on the absolute threshold value information exists, the one determination threshold value is applied as the final determination threshold value. In a range in which both the determination threshold value based on the relative threshold value information and the determination threshold value based on the absolute threshold value information exist, the determination threshold value based on the absolute threshold value information is applied as the final determination threshold value. The determination notification unit 38 uses the determination threshold value in FIG. 6D, and transmits the frame end notification to the frame control unit 60 when the cumulative value in the distance information transmitted from the distance measurement result calculation unit 36 exceeds the determination threshold value.

By configuring the determination notification unit 38 in this manner, it is possible to output the distance measurement result at an appropriate timing according to the state change of the distance measuring object, and it is possible to significantly increase the use value of the distance measurement result.

As described above, according to the present embodiment, it is possible to realize a high-response ranging device capable of quickly outputting a distance measurement result according to a state change of a measurement region.

### Second Embodiment

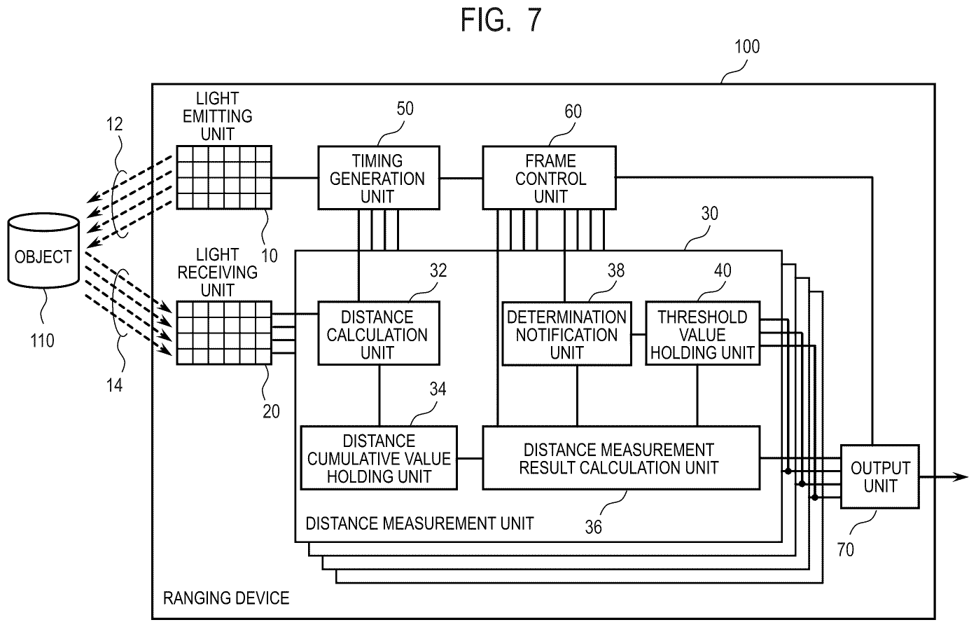

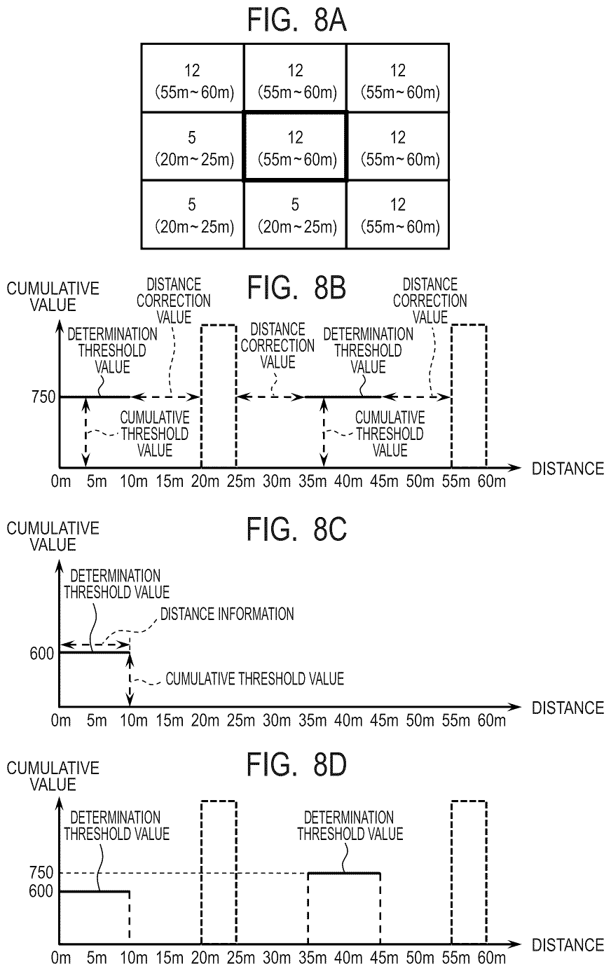

A ranging device and a method of measuring a distance according to a second embodiment of the present invention will be described with reference to FIG. 7 to FIG. 8D. Components similar to those of the ranging device according to the first embodiment are denoted by the same reference numerals, and description thereof will be omitted or simplified. FIG. 7 is a block diagram illustrating a schematic configuration of the ranging device according to the present embodiment. FIG. 8A to FIG. 8D are diagrams illustrating an example of generating a determination threshold value in the ranging device according to the present embodiment.

First, a schematic configuration of the ranging device according to the present embodiment will be described with reference to FIG. 7. The ranging device 100 according to the present embodiment is similar to the first embodiment in that it includes a light emitting unit 10, a light receiving unit 20, a distance measurement unit 30, a timing control unit 50, a frame control unit 60, and an output unit 70. On the other hand, the ranging device 100 according to the present embodiment is different from the first embodiment in that the light receiving unit 20 includes a plurality of light receiving elements and that the ranging device 100 includes a plurality of distance measurement units 30 corresponding to the plurality of light receiving elements.

The light emitting unit 10 is a surface light source having a role of emitting pulse light (irradiation light 12) such as laser light to a measurement target region in response to a control signal from the timing control unit 50. The plurality of light receiving elements constituting the light receiving unit 20 are two-dimensionally arranged, for example, in a matrix. Each of the plurality of light receiving elements corresponds to each of a plurality of areas obtained by dividing a distance measurement area, and is configured to detect reflected light 14 from the corresponding area. The signals output from each of the plurality of light receiving elements are processed in separate distance measurement units 30. As in the first embodiment, each of the plurality of distance measurement units 30 includes a distance calculation unit 32, a distance cumulative value holding unit 34, a distance measurement result calculation unit 36, a determination notification unit 38, and a threshold value holding unit 40.

The timing control unit 50 is connected to the light emitting unit 10, the frame control unit 60, and each of the distance calculation units 32 of the plurality of distance measurement units 30. Each of the light receiving elements constituting the light receiving unit 20 is connected to the distance calculation unit 32 of the corresponding distance measurement unit 30. Each of the distance measurement result calculation units 36 of the plurality of distance measurement units 30 is connected to the output unit 70. Each of the determination notification units 38 of the plurality of distance measurement units 30 is connected to the frame control unit 60. The frame control unit 60 is connected to the output unit 70 and each of the distance measurement result calculation units 36 of the plurality of distance measurement units 30. To the threshold value holding unit 40 of each of the plurality of distance measurement units 30, the distance measurement result calculation unit 36 of the corresponding distance measurement unit 30 and the distance measurement result calculation units 36 of the distance measurement units 30 corresponding to light receiving elements located around a light receiving element corresponding to the corresponding distance measurement unit 30 are connected. The other connections of the respective units in each of the plurality of distance measurement units 30 are similar to those in the first embodiment.

The frame control unit 60 is connected to each of the distance measurement result calculation units 36 of the plurality of distance measurement units 30, and simultaneously transmits the distance measurement result calculation instruction and the distance measurement result output instruction to the distance measurement result calculation units 36 according to the flowchart of FIG. 4. Each of the threshold value holding units 40 of the plurality of distance measurement units 30 receives not only the distance measurement result output by the distance measurement result calculation unit 36 of the corresponding distance measurement unit 30, but also the distance measurement results output by the distance measurement result calculation units 36 of the distance measurement units 30 corresponding to the light receiving elements located around the light receiving element corresponding to the corresponding distance measurement unit 30. Further, each of the determination notification units 38 of the plurality of distance measurement units 30 individually performs a frame end determination processing based on the threshold value information received from the corresponding threshold value holding unit 40, and transmits a frame end notification to the frame control unit 60 when the received information exceeds the determination threshold value.

In the case where the light receiving unit 20 is constituted by a total of 307200 light receiving elements, for example, arranged 640 light receiving elements in the vertical direction×480 light receiving elements in the horizontal direction, 307200 distance measurement results are output to the outside at the end of the frame. The timing control unit 50, the frame control unit 60, and the output unit 70 according to the first embodiment are different from the timing control unit 50, the frame control unit 60, and the output unit 70 according to the present embodiment only in the number of data to be transmitted or received depending on the difference in the number of the distance measurement units 30.

Next, an example of generating the determination threshold value used for the determination in the determination notification unit 38 will be described with reference to FIG. 8A to FIG. 8D. Here, attention is paid to one of the plurality of light receiving elements constituting the light receiving unit 20, and a case is described in which the determination threshold value used for the determination in the determination notification unit 38 of the distance measurement unit 30 corresponding to the light receiving element is generated.

FIG. 8A illustrates a distance measurement result based on a signal output from the light receiving element of interest and distance measurement results based on signals output from the light receiving elements disposed around the light receiving element of interest. Among the nine blocks illustrated in FIG. 8A, the center block indicates the distance measurement result based on the signal output from the light receiving element of interest, and the peripheral blocks indicate the distance measurement results based on the signals output from the eight light receiving elements arranged around the light receiving element of interest. The numerical values described in each block indicate index numbers of bins in the histogram information. Parentheses below the index numbers indicate the distance range corresponding to the bin of the index number. In the present embodiment, the determination threshold value used for the determination in the determination notification unit 38 of the distance measurement unit 30 corresponding to the light receiving element of interest is generated using the nine distance measurement results.

The nine distance measurement results illustrated in FIG. 8A correspond to the “distance measurement result information of previous frame” among the threshold value information held in the threshold value holding unit 40. As illustrated in FIG. 8A, the distance measurement result based on the signal output from the light receiving element of interest indicates that the bin index is 12, and the object 110 exists in the range of 55 m to 60 m. Some of the distance measurement results based on the signals output from the light receiving elements arranged in the periphery have a bin index of 5, indicating that the object 110 exists in a range of 20 m to 25 m. That is, as the “distance measurement result information of previous frame” in this example, two kinds of index 5 and index 12 are selected.

FIG. 8B is a diagram illustrating the determination threshold value generated using the distance correction value and the cumulative threshold value of the relative mode 2 in the information table of FIG. 5 with the indexes of bins as the “distance measurement result information of previous frame” as 5 and 12. As indicated by solid lines in FIG. 8B, the determination threshold value is set to the bins spaced apart two or more bins, that is given as the “distance correction value”, from the bins indicated in the column of “distance measurement result information of previous frame” at a height position of the cumulative value 750 given as the cumulative threshold value. Here, since two indexes are designated as the “distance measurement result information of previous frame”, the range of the distance correction value is provided corresponding to each of the two bins.

The reason why the distance measurement information based on the signals output from the peripheral light receiving elements is also used for generating the determination threshold value is that it is assumed that the object in the light receiving range of the peripheral light receiving element enters the light receiving range of the light receiving element of interest in the next frame. By also considering the distance measurement information based on the signals output from the peripheral light receiving elements, it is possible to appropriately grasp whether the object detected in the light receiving element of interest is the object moving in the imaging area or the object appearing suddenly. Thus, unnecessary frame end processing may be prevented from being performed within a predetermined frame period.

FIG. 8C is a diagram illustrating the determination threshold value generated using the distance information and the cumulative threshold value of the absolute mode 1 in the information table of FIG. 5. As indicated by a solid line in FIG. 8C, the determination threshold value is set to a height position of the cumulative value 600 given as the cumulative threshold value in a range of two bins given as a “distance correction value” from the distance 0 m. The determination threshold value of FIG. 8C is the same as the determination threshold value of FIG. 6C.

FIG. 8D is a diagram illustrating the final determination threshold value generated from the determination threshold value based on the relative threshold value information and the determination threshold value based on the absolute threshold value information. Solid lines in FIG. 8D indicate the final determination threshold value. In the distance range where only one of the determination threshold value based on the relative threshold value information and the determination threshold value based on the absolute threshold value information exists, the one determination threshold value is applied as the final determination threshold value. In a range in which both the determination threshold value based on the relative threshold value information and the determination threshold value based on the absolute threshold value information exist, the determination threshold value based on the absolute threshold value information is applied as the final determination threshold value. The determination notification unit 38 uses the determination threshold value in FIG. 8D, and transmits the frame end notification to the frame control unit 60 when the cumulative value in the distance information transmitted from the distance measurement result calculation unit 36 exceeds the determination threshold value.

In the case where the light receiving unit 20 is composed of a plurality of light receiving elements, each of the determination notification units 38 of the plurality of distance measurement units 30 corresponding to the plurality of light receiving elements may be individually set to be on or off. For example, in order to quickly detect intrusion of an object from outside the range of the distance measurement area while realizing power reduction or processing load reduction, only the determination notification unit 38 of the distance measurement unit 30 corresponding to the light receiving element positioned at the outer edge of the light receiving area of the light receiving unit 20 may be turned on. Further, for the purpose of reducing the circuit scale, the determination notification unit 38 and the threshold value holding unit 40 may be mounted only on the distance measurement unit 30 corresponding to the light receiving element positioned at the outer edge portion of the light receiving area of the light receiving unit 20.

In addition, when there is no frame end notification from the determination notification unit 38 within a predetermined frame period, the end of the frame and the start of the next frame may be performed without outputting the distance measurement result from the threshold value holding unit 40 and the output unit 70 to the outside for the purpose of power reduction or the like.

As described above, according to the present embodiment, it is possible to realize a high-response ranging device capable of quickly outputting a distance measurement result according to a state change of a measurement region.

### Third Embodiment

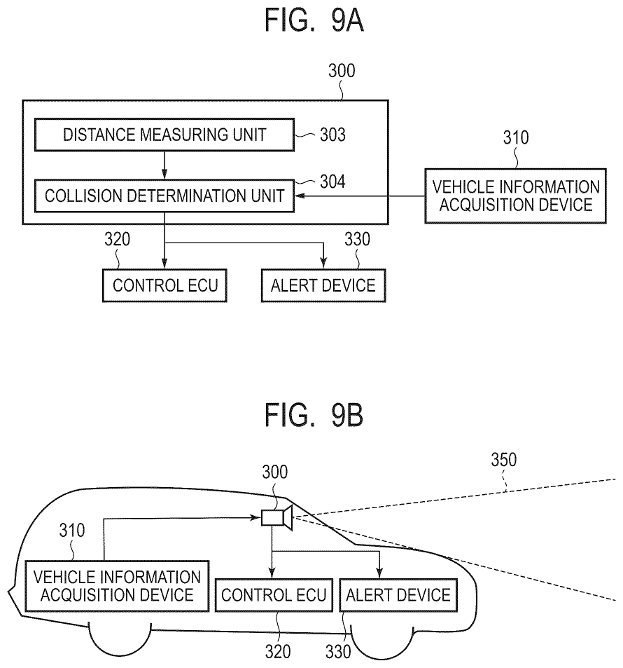

A movable object according to a third embodiment of the present invention will be described with reference to FIG. 9A and FIG. 9B. FIG. 9A and FIG. 9B are diagrams illustrating a configuration example of a movable object according to the present embodiment.

FIG. 9A illustrates a configuration example of equipment mounted on a vehicle as an on-vehicle camera. The equipment 300 includes a distance measurement unit 303 that measures a distance to an object, and a collision determination unit 304 that determines whether or not there is a possibility of collision based on a distance measured by the distance measurement unit 303. The distance measurement unit 303 includes the ranging device 100 described in the first or second embodiment. The distance measurement unit 303 is an example of a distance information acquisition unit that obtains distance information to the object. That is, the distance information is information on a distance to the object or the like.

The equipment 300 is connected to the vehicle information acquisition device 310, and may obtain vehicle information such as a vehicle speed, a yaw rate, and a steering angle. Further, a control ECU 320, which is a control device for outputting a control signal for generating a braking force to the vehicle, is connected to the equipment 300 based on the determination result of the collision determination unit 304. The equipment 300 is also connected to an alert device 330 that issues an alert to the driver based on the determination result of the collision determination unit 304. For example, when the collision possibility is high as the determination result of the collision determination unit 304, the control ECU 320 performs vehicle control to avoid collision and reduce damage by braking, returning an accelerator, suppressing engine output, or the like. The alert device 330 alerts the user by sounding an alarm such as a sound, displaying alert information on a screen of a car navigation system or the like, or giving vibration to a seat belt or a steering wheel. These devices of the equipment 300 function as a mobile control unit that controls the operation of controlling the vehicle as described above.

In the present embodiment, the equipment 300 measures the distance around the vehicle, for example, the front or the rear. FIG. 9B illustrates a device when distance measurement is performed in front of the vehicle (distance measurement range 350). The vehicle information acquisition device 310 as the distance measurement control means sends an instruction to the equipment 300 or the distance measurement unit 303 to perform the distance measurement operation. With such a configuration, the accuracy of distance measurement may be further improved.

In the above description, an example has been described in which control is performed so as not to collide with other vehicles, but the present invention may also be applied to control of automatic driving following other vehicles, control of automatic driving so as not to go out of a lane, and the like. Further, the device is not limited to a vehicle such as an automobile, and may be applied to a movable object (moving device) such as a ship, an aircraft, an artificial satellite, an industrial robot, or a consumer robot. In addition, the present invention may be applied not only to a movable object but also to a wide variety of equipment using object recognition or biological recognition, such as an ITS (Intelligent Transport Systems) and a monitoring system, and the like.

### Modified Embodiments

The present invention is not limited to the above-described embodiments, and various modifications are possible.

For example, examples in which some of the configurations of any of the embodiments are added to other embodiments or examples in which some of the configurations of any of the embodiments are substituted with some of the configurations of the other embodiments are also an embodiment of the present invention.

Further, in the above-described embodiments, although the histogram information is generated by generating the distance data indicating the distance to the object based on the timing at which the light irradiated to the object is detected by the light receiving element and counting the distance date for each class of the distance, the histogram information may be generated by using the other method. For example, the signals output from the light receiving element may be counted in a time-division manner at predetermined time intervals and converted into the histogram information indicating the relationship between the distance and the frequency. When the SPAD sensor is used as the light receiving element, the photon detection pulses output from the SPAD sensor may be counted, and the counted value may be used as an cumulative value.

Further, in the above-described embodiment, the histogram information is generated after the time information is converted into the distance information, but the histogram information indicating the relationship between the time and the frequency may be generated to perform the same processing as in the above embodiment, and the distance information may be changed from the time information to the distance information when the calculation result is output.

In the above-described embodiment, the light emitting unit 10 and the light receiving unit 20 are described as a part of the components of the ranging device 100, but at least one of the light emitting unit 10 and the light receiving unit 20 need not necessarily be a part of the components of the ranging device 100.

Although the ranging device has been described in the above embodiment, the algorithm described in the above embodiment may be applied to an information processing device for processing distance data indicating a distance to an object. In this case, in the components of the ranging device 100 illustrated in FIG. 1, the distance measurement unit 30, the timing control unit 50, the frame control unit 60, and the output unit 70 may be configured by the information processing device. The information processing device may be an apparatus such as a personal computer including a processor (e.g., CPU (central processing unit) or MPU (micro processing unit)). Alternatively, the information processing device may be a circuit such as an ASIC (application specific integrated circuit) that realizes functions of the distance measurement unit 30, the timing control unit 50, the frame control unit 60, and the output unit 70.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-117782, filed Jul. 25, 2022 which is hereby incorporated by reference herein in its entirety.

What is claimed is:

1. A ranging device comprising:
a light receiving unit including a light receiving element;
a frequency distribution generation unit configured to generate a frequency distribution indicating a relationship between a distance and a frequency based on a timing at which light irradiated to an object is detected by the light receiving element;
a control unit configured to control a frame period that is a period from a start to an end of counting of distance data in the frequency distribution generation unit; and
a distance measurement result calculation unit configured to calculate a distance measurement result based on the frequency distribution,
wherein the distance measurement result calculation unit periodically acquires the frequency distribution from the frequency distribution generation unit during a predetermined period set in advance as the frame period,
wherein, when the frequency of any of the classes in the acquired frequency distribution exceeds a predetermined threshold value,
the distance measurement result calculation unit determines a distance range of a class in which the frequency exceeds the threshold value as a distance measurement result, and
the control unit outputs the distance measurement result from the distance measurement result calculation unit before the predetermined period to elapse, and ends the frame period.

2. The ranging device according to claim 1,
wherein the distance measurement result calculation unit determines a distance range of a class having the highest frequency among the acquired frequency distribution as the distance measurement result, and
wherein when the frequency of the class corresponding to the distance measurement result exceeds the threshold value, the control unit outputs the distance measurement result from the distance measurement result calculation unit without waiting for the predetermined period to elapse, and ends the frame period.

3. The ranging device according to claim 1, wherein, when the predetermined period has elapsed without that the frequencies of all classes in the acquired frequency distribution exceed the threshold value,
the distance measurement result calculation unit determines a distance range of a class having highest frequency among the acquired frequency distribution as the distance measurement result, and
the control unit outputs the distance measurement result from the distance measurement result calculation unit, and ends the frame period.

4. The ranging device according to claim 1, wherein, when the predetermined period has elapsed without that the frequencies of all classes in the acquired frequency distribution exceed the threshold value,
the control unit ends the frame period without outputting the distance measurement result from the distance measurement result calculation unit.

5. The ranging device according to claim 1, wherein the threshold value is set to each of a plurality of classes constituting the frequency distribution.

6. The ranging device according to claim 1, wherein the threshold value is set to a class excluding a class corresponding to a distance measurement result output in a previous frame period and a predetermined number of classes adjacent to the class corresponding to the distance measurement result output in the previous frame period among a plurality of classes constituting the frequency distribution.

7. The ranging device according to claim 6,
wherein the light receiving unit includes a plurality of light receiving elements, and the ranging device includes a plurality of frequency distribution generation units and a plurality of distance measurement result calculation units each corresponding to the plurality of light receiving elements, and
wherein the distance measurement result output in the previous frame period is a distance measurement result output from distance measurement result calculation units corresponding to one light receiving element and a light receiving element adjacent to the one light receiving element in the previous frame period.

8. The ranging device according to claim 1, wherein the frequency distribution includes a first class and a second class located closer to a shorter distance than the first class, and the threshold value set in the second class is smaller than the threshold value set in the first class.

9. The ranging device according to claim 1 further comprising a threshold value holding unit configured to hold threshold value information including the threshold value,
wherein when the distance measurement result in a certain frame period is determined, the threshold value information is updated based on data of the class and the frequency corresponding to the distance measurement result.

10. The ranging device according to claim 1,
wherein the light receiving unit includes a plurality of light receiving elements, and the ranging device includes a plurality of distance calculation units, a plurality of frequency distribution generation units, and a plurality of distance measurement result calculation units each corresponding to the plurality of light receiving elements, and
wherein a determination of whether or not frequencies in the frequency distribution exceeds the threshold value is performed for the frequencies of the frequency distributions corresponding to a part of the light receiving elements among the plurality of light receiving elements.

11. The ranging device according to claim 10, wherein the part of the light receiving elements is positioned at an outer edge of a light receiving area of the light receiving unit.

12. The ranging device according to claim 1 further comprising a distance calculation unit configured to generate distance data indicating a distance to the object based on a timing at which light irradiated to the object is detected by the light receiving element,
wherein the frequency distribution generation unit generates the frequency distribution by counting the distance data output from the distance calculation unit for each class of distances.

13. The ranging device according to claim 1, wherein the frequency distribution generation unit generates the frequency distribution by counting the signals output from the light receiving element in a time division manner.

14. An information processing device that processes distance data indicating a distance to an object comprising:
a frequency distribution generation unit configured to generate a frequency distribution by counting of distance data for each class defined by distances;
a control unit configured to control a frame period that is a period from a start to an end of counting of the distance data in the frequency distribution generation unit; and
a distance measurement result calculation unit configured to calculate a distance measurement result based on the frequency distribution,
wherein the distance measurement result calculation unit periodically acquires the frequency distribution from the frequency distribution generation unit during a predetermined period set in advance as the frame period,
wherein, when the frequency of any of the classes in the acquired frequency distribution exceeds a predetermined threshold value,
the distance measurement result calculation unit determines a distance range of a class in which the frequency exceeds the threshold value as a distance measurement result, and
the control unit outputs the distance measurement result from the distance measurement result calculation unit before the predetermined period to elapse, and ends the frame period.

15. A movable object comprising:
the ranging device according to claim 1; and
a control unit configured to control the movable body based on distance information acquired by the ranging device.

16. A method of measuring a distance by generating a frequency distribution indicating a relationship between a distance and a frequency based on a timing at which light irradiated to an object is detected by a light receiving element, and calculating a distance measurement result based on the frequency distribution, the method comprising:
periodically acquiring the frequency distribution during a predetermined period set in advance as a frame period that is a period from a start to an end of the counting of the distance data;
determining whether or not the frequency of any of the classes in the acquired frequency distribution exceeds a predetermined threshold value, and
when the frequency exceeds the threshold value, determining a distance range of a class in which the frequency exceeds the threshold value as a distance measurement result, and ending the frame period before the predetermined period to elapse.
